(19) United States
(12) Patent Application Publication
(10) Pub. No.: US 2012/0117922 A1
(43) Pub. Date: May 17, 2012

(54) HEATING PLATE WITH A MULTIPLICITY OF HEATING CARTRIDGES AND METHOD OF HEATING

(75) Inventor: Klaus Meyer, Breidenbach (DE)

(73) Assignee: CFS GERMANY GMBH, Biedenkopf-Wallan (DE)

(21) Appl. No.: 13/358,787

(22) Filed: Jan. 26, 2012

Related U.S. Application Data
(63) Continuation of application No. 12/440,656, filed on Jul. 27, 2009.

(30) Foreign Application Priority Data
Sep. 22, 2006 (DE) 10 2006 045 327.1

(51) Int. Cl. B65B 47/00; B31B 1/00

(52) U.S. Cl. 53/453; 493/267

(57) ABSTRACT

The present invention relates to a packaging machine with a forming station, which forms depressions in a sheet of film, wherein a heating element heats the sheet of film before the deforming, in which the heating element has a multiplicity of discrete heating means which can be activated individually or in groups, and so the sheet of film has temperature gradients.

### CLAIM OF PRIORITY

“The present application is a divisional application of application Ser. No. 12/440,656, filed Mar. 10, 2009 (371 date of Jul. 27, 2009), which claims the benefit of the priority of Application No. PCT/EP2007/008216 (Published as WO2008/034624), filed on Sep. 21, 2007, and Germany 10 2006 045 327.1 with a filing date of Sep. 22, 2006, all of which are incorporated herein by reference for all purposes.”

### FIELD

The present invention relates to a packaging machine having a forming station which forms cavities in a film web, a heating element heating the film web before the deformation.

### BACKGROUND

The packaging machines of the generic type are known from the prior art. In said packaging machines, a cavity is formed in a planar film web by deep drawing. For this purpose, the film web has to be heated with a heating element before the deep drawing. During the deep drawing, the film web is loaded variably. In particular in the region of corners and, in the edge region, the film web is expanded to a substantially more pronounced extent than for example, on the base of the cavity or in the region of the sealing seam. In order to avoid the film becoming too thin in these regions, thicker film webs are used which has a disadvantageous effect on the costs, the transport and the disposal of the packaging which is to be produced.

It was therefore the object of the present invention to provide a packaging machine which does not have the disadvantages of the prior art.

### SUMMARY

The object is achieved by a packaging machine having a forming station which forms cavities in a film web, a heating element heating the film web before the deformation, in which packaging machine the heating element has a multiplicity of discrete heating means which can be actuated individually or in groups, with the result that the film web has temperature gradients before the deformation.

According to a further subject or a preferred subject of the abovementioned invention, the packaging machine has a sealing mold, by way of which an upper film is sealed to the packaging cavity, the sealing mold having a heating element to heat it, the heating element having a multiplicity of discrete heating means which can be actuated individually or in groups.

According to the invention, the heating element has a multiplicity of discrete heating means which can be actuated individually or in groups. As a result, it is possible to produce a very defined temperature profile in the film web, which temperature profile corresponds to the respective deep drawing requirements. For example, the temperature should be lower in the corner regions of the packaging, with the result that no weak points are produced in the packaging cavities which are to be manufactured. In the other regions of the film web, from which the packaging is manufactured, the temperature is higher, for example. Desired temperature profiles can also be, achieved in the sealing mold by the discrete heating means. Sealing seams of different strengths can be achieved by the level of the temperature in the region of the sealing frame which is in contact with the film web and which produces the actual sealing seam, wherein a higher temperature as a rule results in a stronger sealing seam. The remainder of the sealing mold is preferably heated to a less pronounced extent than the region of the sealing frame. This not only saves energy but is also advantageous, for example, in the processing of shrinkable films which are not to shrink, or are to shrink only a little, in the sealing mold.

The heating means can preferably be operated with a different voltage, with the result that the individual heating means can not only be switched on and off, but can also be operated in each case with a different heat output.

The heating means very particularly preferably has temperature sensors, for example thermocouples, by way of which the temperature of the heating means can be measured locally. In one particularly preferred embodiment of the packaging machine according to the invention, the signal of said temperature sensors is used to regulate the electrical voltage at one or more heating means.

Furthermore, the packaging machine according to the invention preferably has means for improving the thermal exchange between the film web and the heating means. These means can be, for example, vacuum channels, by way of which the film is sucked onto the heating element. A further possibility comprises pressing the film against the heating, means by way of pressure.

In a further preferred embodiment, the heating element has means for local cooling. This embodiment of the packaging machines according to the invention is advantageous, in particular, when the heating plate is to have regions which are not to be heated or are to be heated only very slightly, but which are nevertheless heated by the thermal conduction in the heating plate.

The heating means is preferably controlled by a computer. This computer can be used to determine which heating element is loaded with voltage and how high this voltage is. The distribution of the heat output can therefore be programmed freely and stored. An optimum temperature distribution can therefore be stored and called up as required for each packaging format which is manufactured on the packaging machine according to the invention. This temperature distribution can also be a function of the film type to be processed in each case. The deep drawing mold and/or the sealing mold particularly preferably have/has an identification, for example a barcode or a transponder. As soon as said identification has been input or automatically, read into the computer, the desired temperature profile is called automatically and the heating means are actuated correspondingly in each case.

The invention will be explained in the following text using FIGS. 1 to 5. These explanations are merely by way of example and do not restrict the general concept of the invention.

### BRIEF DESCRIPTION OF THE DRAWINGS

In the drawing:

FIG. 1 diagrammatically shows the packaging machine according to the invention;

FIG. 2 shows the heating element of the packaging machine;

FIG. 3 shows an operating form of the heating element of the packaging machine;

FIG. 4 shows a further operating form of the heating element of the packaging machine; and

FIG. 5 shows an operating form of the sealing mold of the packaging machine.

### DETAILED DESCRIPTION

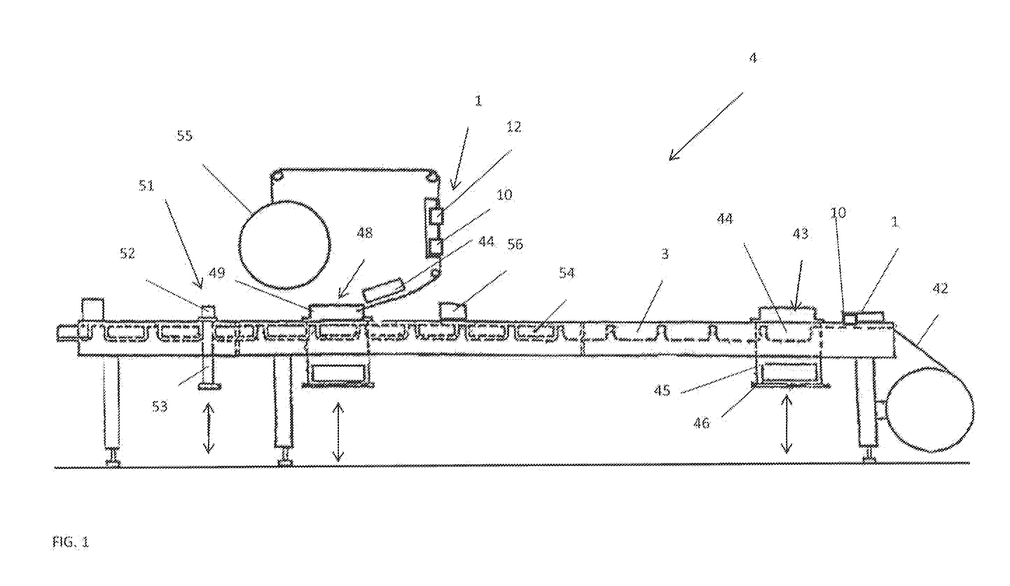

FIG. 1 shows a diagrammatic illustration of one possible embodiment of the packaging machine according to the invention. An underfilm 42 is unrolled from a reel and is first of all heated by way of a heating element 1. Subsequently, the underfilm is deep drawn in a forming station 43. Said forming station 43 has a top mold 44 and a lower mold 45 which is arranged on a support 46. As shown by the double arrow, the support 46 and therefore the lower mold 45 can be displaced vertically. As soon as the packaging cavities 3 are formed into the underfilm web 42, they are filled with the material to be packaged 54. Subsequently, before the packaging cavities pass into the sealing station 48, holes which are required for the gas exchange in the packaging within the sealing station are punched into the underfilm by means of a punch 56. In the sealing station 48, an upper film 55 is sealed onto the underfilm 42 and the packagings are therefore closed. In the present case, the upper film is also heated by means of a heating element 1 and is then deep drawn by means of the deep drawing mold 44. This deep drawing can serve to provide an arched lid for the packagings. However, the deep drawing can also serve to make the upper film shrinkable. The sealing station also has a top mold 49 and a lower mold 50, which are pressed against one another during sealing. A sealing frame which is likewise heated by means of a heating element is situated in the top mold 49. The heating element 1 includes a temperature sensor 10 and a means 12 for local cooling. Finally, the packagings which are then closed are separated in a cutting station 51. The cross cutting means of the cutting station likewise has a top mold 52 and a tower mold 53, it being possible for the lower mold 53 to be displaced vertically in turn.

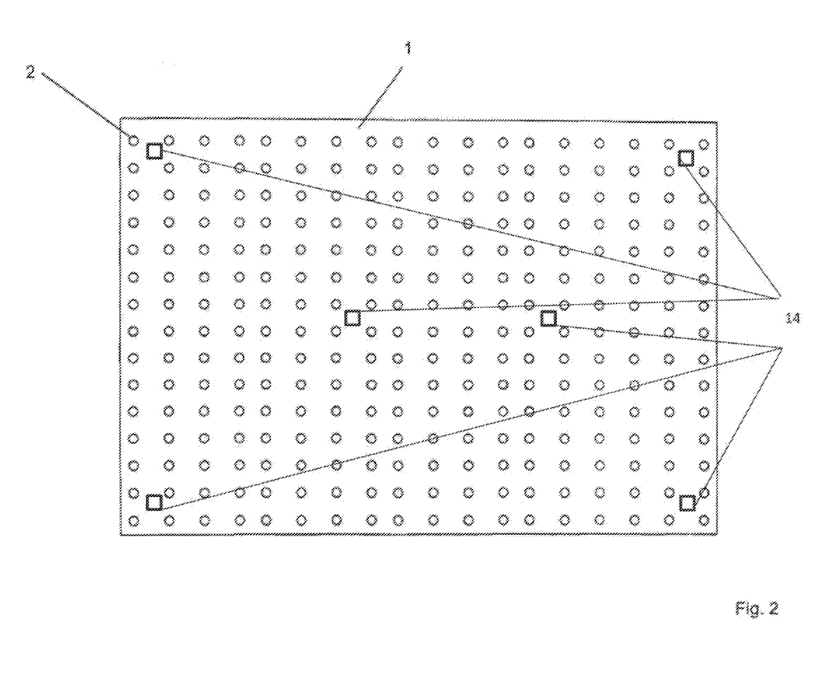

FIG. 2 shows a heating element 1 which can be used to heat the underfilm and upper film and which can also be situated in the sealing molds 49, 50 of the sealing station 48. Said heating element has a multiplicity of heating means 2 which are arranged in a very defined uniform or nonuniform, preferably uniform, pattern. The heating element 1 includes a means 14 for improving the thermal exchange between the film web and the heating means 2. The heating means 2 can be actuated individually or in groups, preferably individually, by a control element. The heating means can be switched on or off and their heat output can be regulated by way of the controller. A very defined temperature profile can therefore be achieved in the respective film or in the sealing operation. In the case of a format change, that is to say when other packagings are to be manufactured, a different desired temperature distribution can be set by means of the controller of the packaging machine. In this case, other or additional heating means are then actuated or operated with a different heat output. This embodiment of the present invention has the advantage that the heating means can be adapted simply to the format which is to be manufactured in each case. In one advantageous embodiment of the present invention, the respective deep drawing, or sealing, mold has a transponder which transmits a defined signal to the control unit. As soon as the control unit receives this signal, it actuates the respective heating means automatically in such a way that the optimum temperature distribution for the respective mold is achieved in the film web 42, 45 or during sealing. This temperature profile can also be a function of the film which is used, with the result that the operator of the packaging machine according to the invention optionally still has to communicate the film type to the controller of the packaging machine.

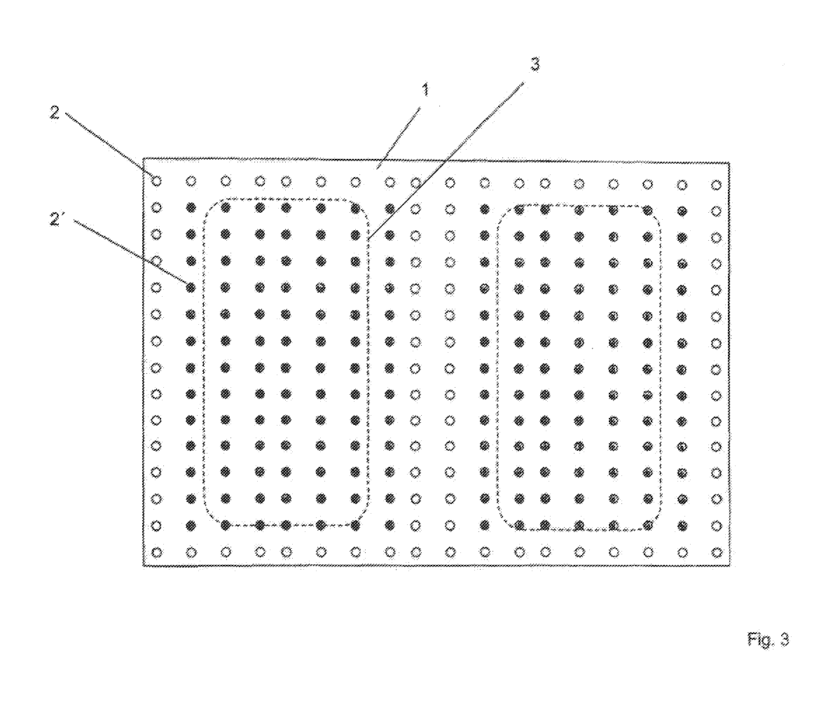

FIG. 3 uses dashed lines to show the outlines of a packaging cavity which is to be manufactured. In the present case, for example, the heating means 2′ which are emphasized in gray are operated on account of the shape of said packaging cavity, while the other heating means 2 have a lower temperature. The intensity of the respective heating means is a function of the desired temperature profile in the film.

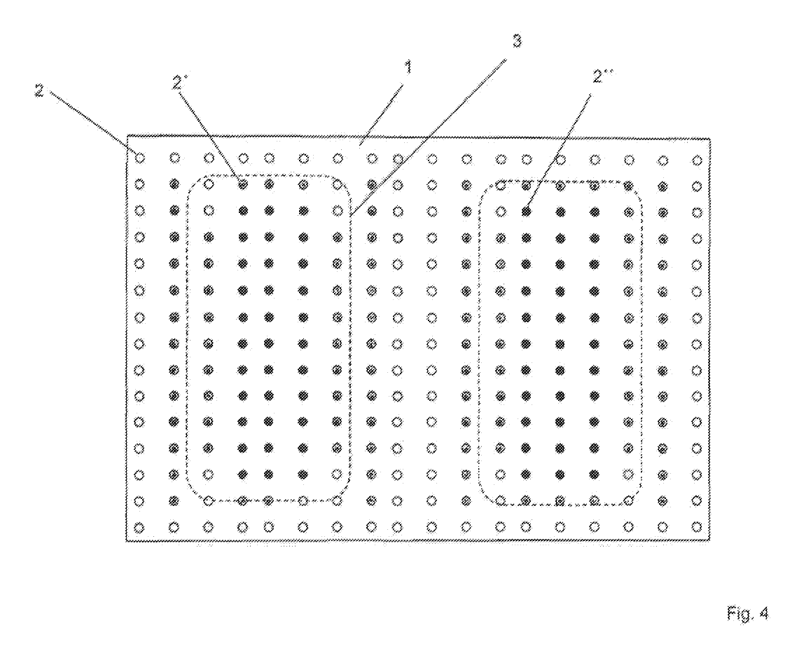

FIG. 4 shows another operating state of the heating plate of the packaging apparatus according to the invention. In the present case, the heating plate also has heating means 2″ which are emphasized in black and are intended to signal a higher temperature than the heating means which are emphasized in gray. In the present case, it is advantageous, in particular, to heat the film sections which form the corner of a packaging only to a very weak extent, in order to prevent excessive flow. Once it has been found, the optimum temperature distribution in the heating plate and the associated actuation of the heating means 2 are stored and can be called up manually or automatically. As a result, changeover times are reduced considerably.

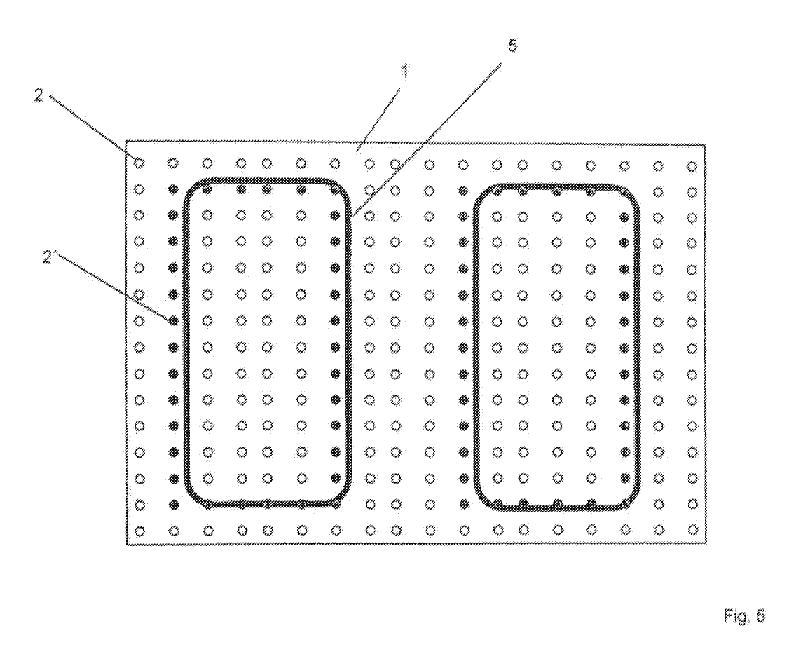

FIG. 5 shows the heating means of a sealing mold. The sealing frame has the designation 5 and is not a constituent part of the heating plate 1, but rather is arranged in front of the latter. The sealing frame represents a mold which is adapted to the packaging format which is to be produced in each case. Here, the sealing frame can also have a transponder or another identification medium which meets the above described function. It can be seen in this case that only the heating cartridges 2′ which are emphasized in gray and are situated in the region of the sealing frame are heated, while the other heating cartridges are switched off. This embodiment saves energy and is advantageous, in particular, when shrinkable films which are not intended to shrink during sealing are used as underfilm or upper film.

### LIST OF DESIGNATIONS

1 Heating Element

2, 2′, 2″ Heating Means, Heating Cartridge

3 Packaging Cavity

4 Packaging Machine

5 Sealing Frame

42 Underfilm Web

43 Forming Station

44 Top Mold of the Forming Station

45 Lower Mold of the Forming Station

46 Support of the Lower Mold of the Forming Station

48 Sealing Station

49 Top Mold of the Sealing Station

50 Lower Mold of the Sealing Station

51 Cutting Station

52 Top Mold of the Cutting Station

53 Lower Mold of the Cutting Station

54 Material to be Packaged

55 Upper Film

56 Punches

1. A method of forming a package comprising: heating a heating element that has a multiplicity of discrete heating means which can be actuated individually or in groups, with the result that a film web heated by the heating element has temperature gradients.

2-6. (canceled)

7. The method of claim 1, wherein the film web is heated before formation of cavities in the film web.

8. The method of claim 1, wherein the heating element heats the film web before a sealing mold and the film web is sealed to a packaging cavity.

9. The method of claim 1, wherein the heating means are operated with a different voltage.

10. The method of claim 1, wherein the heating element has at least one temperature sensor for controlling the heating means.

11. The method of claim 1, wherein the discrete heating means are controlled, so that sections of the film web are heated to different temperatures prior to drawing so that flow of the film web in selected locations during drawing is controlled.

12. The method of claim 1, wherein the heating element is located in a packaging machine that operates to deep draw the film web that unrolls from a reel at a forming station, to form a plurality of cavities that receive material to be packaged, and to seal the plurality of cavities having the material therein, with an upper film at a sealing station.

13. The method of claim 1, wherein the heating element is part of a packaging machine and the packaging machine has a means for improving a thermal exchange between the film web and the heating element.

14. The method of claim 1, wherein the heating element is controlled by a computer.

15. The method of claim 1, wherein the heating element is located in a packaging machine having:
a) a forming station which forms cavities in the film web, the forming station including the heating element to heat the film web before formation of the cavities in the film web, and
b) a sealing mold which seals an upper film to the packaging cavity, the sealing mold including the heating element to heat the film we before sealing the upper film to the packaging cavity.

16. The method of claim 7, wherein the film web is heated to a lower temperature in corner regions of the cavity to be produced than a region around the corner regions so that the resulting cavities are free of weak points in the corner regions.

17. The method of claim 8, wherein the film web is heated to a higher temperature in a sealing region that contacts the packaging cavity to be sealed than a surrounding region.

18. The method of claim 15, wherein the film web is heated to a lower temperature in corner regions of the cavity to be produced than a region around the corner regions so that the resulting cavities are free of weak points in the corner regions, and
the upper film is heated to a higher temperature in a sealing region that contacts the packaging cavity to be sealed than a surrounding region.

19. The method of claim 15, wherein the heating element of the forming station, the sealing mold, or both include a means for local cooling.

20. The method of claim 18, wherein the heating element of the forming station, the sealing mold, or both include a means for local cooling.

21. The method of claim 15, wherein the heating element has at least one temperature sensor for controlling the heating means.

22. The method of claim 18, wherein the heating element has at least one temperature sensor for controlling the heating means.

23. The method of claim 15, wherein the heating element is controlled by a computer.

24. A method comprising:
a) transporting a film through a packaging machine having:
i. a forming station, which forms cavities in the film,
ii. a sealing mold, which seals an upper film around the cavities in the film,
iii. one or more heating elements that include a multiplicity of discrete heating means, and
iv. a computer that controls the one or more heating elements;
b) heating the film, the upper film, or both with a heating element that includes a multiplicity of discrete heating means;
c) switching the heating means on or off individually or in groups so that the film, the upper film, or both have temperature gradients;
d) forming cavities in the film;
e) filling the cavity; and
f) sealing the cavity;
wherein the film is heated before formation of the cavities in the film, before the upper film is sealed around the cavity, or both.

25. The method of claim 24, wherein switching the heating means on or off includes selectively heating:
the film so that corner regions of the cavity to be produced have a lower temperature than a region around the corner regions;
the upper film so that a sealing region that contacts to the packaging cavity to be sealed is heated to a higher temperature than a region around the sealing region; or both.
